(19) United States
(12) Patent Application Publication
(10) Pub. No.: US 2015/0028119 A1
(43) Pub. Date: Jan. 29, 2015

(54) Method of Heating the Interior of a Vehicle

(71) Applicant: Bayerische Motoren Werke Aktiengesellschaft, Muenchen (DE)

(72) Inventors: Peter SATZGER, Landsberg am Lech (DE); Robert HERBOLZHEIMER, Groebenzell (DE); Eugen FEINMANN, Muenchen (DE)

(21) Appl. No.: 14/339,700

(22) Filed: Jul. 24, 2014

(30) Foreign Application Priority Data
Jul. 25, 2013 (DE) 102013214555.1

(51) Int. Cl. B60H 1/22

(52) U.S. Cl. CPC B60H 1/2218; B60H 1/2215
USPC 237/28

(57) ABSTRACT

A method of heating the interior of a vehicle is provided, particularly of a hybrid or electric vehicle. The vehicle has a central heating system and several decentralized heating surfaces constructed as infrared radiators. The temperature of the vehicle interior is controllable by the central heating system and/or the decentralized heating surfaces corresponding to a heating demand of at least one vehicle occupant. For controlling the temperature of the interior by way of the decentralized heating surfaces, the heating power of at least one decentralized heating surface is specified or influenced as a function of the position of the vehicle occupant or of a part of the vehicle occupant's body relative to the respective decentralized heating surface or to a defined group of several decentralized heating surfaces.

### CROSS REFERENCE TO RELATED APPLICATIONS

This application claims priority under 35 U.S.C. §119 from German Patent Application No. 10 2013 214 555.1, filed Jul. 25, 2013, the entire disclosure of which is herein expressly incorporated by reference.

This application contains subject matter related to U.S. application Ser. No. ______, entitled “Method of Heating the Interior of a Vehicle” filed on even date herewith.

### BACKGROUND AND SUMMARY OF THE INVENTION

The invention relates to a method of heating the interior of a vehicle, particularly of a hybrid or electric vehicle, the vehicle having a central heating system and several decentralized heating surfaces constructed as infrared radiators, and the temperature of the vehicle interior being controllable by the central heating system and/or the decentralized heating surfaces corresponding to a heating demand of at least one vehicle occupant.

Currently, the temperature of most vehicles is controlled by use of a conventional heating and cooling system corresponding to the driver's demands. In addition to having this conventional heating system, many vehicles are also equipped with a seat heating system, which can be activated by the driver or by the person situated in the seat. This seat heating system only sets the temperature of the seat corresponding to the adjusted activation stage and is controlled completely independently of the conventional heating/cooling system.

From the prior art, in addition to the conventional heating system, electric heating systems are also known for setting the temperature of the vehicle interior. Thus, German Patent Document DE 198 08 571 B4 discloses a heating device in addition to the conventional heating and air-conditioning system, which additional heating device consists of at least one infrared radiator which is installed in the vehicle interior in the manner of a decentralized heating system. The heat output of the infrared radiator can be automatically controlled by a corresponding automatic control device, which provides a heat output of the infrared radiator that is the lower, the higher the heat output of the conventional heating system is set.

Furthermore, from German Patent Document DE 10 2011 077 993 A1, a vehicle having a heating and cooling system is known, in which case at least a part of the heating and cooling system is arranged in a decentralized manner in the proximity of the individual seat areas of the vehicle. In this case, the control of the decentralized heating and cooling system takes place as a function of the seat occupation.

It is an object of the invention to provide an improved method of heating the interior of a vehicle by way of at least one decentralized heating system.

This and other objects are achieved by a method of heating the interior of a vehicle, particularly of a hybrid or electric vehicle, the vehicle having a central heating system and several decentralized heating surfaces constructed as infrared radiators, and the temperature of the vehicle interior being controllable by the central heating system and/or the decentralized heating surfaces corresponding to a heating demand of at least one vehicle occupant. For controlling the temperature of the interior by way of the decentralized heating surfaces, the heating power of at least one decentralized heating surface is specified or influenced as a function of a position of the vehicle occupant or of a part of the vehicle occupant's body relative to the respective decentralized heating surface or a defined group of several decentralized heating surfaces. The method according to the invention as well as its advantageous further developments can be implemented by way of an algorithm or a corresponding arrangement of assemblies in a control device provided for that purpose.

The invention is based on the fact that the vehicle, in which the method according to the invention is to be used for heating the interior of a vehicle, has several decentralized heating surfaces in addition to a conventional central heating system, the decentralized heating surfaces being designed as infrared heating surfaces.

The infrared heating surfaces may be constructed and further developed such that the actual infrared radiator, which consists, for example, of a foil, which is further developed as a radiation generator and through which current flows, on the backside facing away from the vehicle interior, borders on an insulation layer and, on the front side facing the vehicle interior, borders on a heat-transmitting decorative surface, so that the occupant is protected from direct contact with the infrared radiator. The heating surfaces may be arranged at different points in the vehicle interior, for example, in the door panel, in the floor covering, in the area of the center console, in the knee area, in the area of the A-, B- or C-pillar, the elbow space, the vehicle ceiling, on the front side of the seats or at the rearward covering of the seats, the tunnel or the lateral surfaces of the armrests.

By use of such infrared heating surfaces, an immediate warming of the occupants without any air movement and without any noise can be achieved by the direct energy transmission of the infrared radiation.

Basically, the controlling of the temperature of the interior can either take place by the sole actuation of the conventional heating system or by the sole actuation of the decentralized heating surfaces or by a combined actuation of both heating systems. The power distribution can be specified either by a manual demand or automatically.

It is the basic idea of the invention to always generate a pleasant feeling of warmth, particularly a homogeneous warmth for the occupants, by actuating the decentralized heating surfaces; i.e. the decentralized heating surfaces—provided that, at least partially, the decentralized heating surfaces are used for controlling the temperature of the interior—are to be actuated such that the occupant has the sensation that the same feeling of warmth is occurring in all parts of the body exposed to the radiation. According to the invention, this can be achieved in that, for controlling the temperature in the vehicle interior by way of the decentralized heating surfaces, at least one decentralized heating surface is specified or influenced as a function of the position of the vehicle occupant or of a part of the vehicle occupant's body relative to the respective decentralized heating surface or relative to a defined group of several decentralized heating surfaces, particularly as a function of the distance between the occupant or the part of the occupant's body and the relevant heating surface.

In order to be able to achieve a homogeneous feeling of warmth on the part of the occupant, the heating power of the heating surfaces actuated for the warming of an area surrounding an occupant may be specified or influenced such that the warmth impinging on the occupant's body or the heating power on all sides or parts of the body that are exposed to the radiation is almost equal. A clearly more comfortable condition is thereby achieved for the occupant because the symmetry of the warmth arriving at the occupant is decisive for the thermo-physical feeling.

In addition to ensuring an almost even heat radiation onto all parts of the vehicle occupant's body exposed to the radiation, the heating power can also be specified or influenced such that the heat/heating power impinging on the occupant's body, in the event of a changing relative position of the vehicle occupant and/or a part of the vehicle occupant's body during a heating demand remains almost even; i.e., also when the distance from the actuated heating surfaces changes, the vehicle occupant always feels an almost even heat radiation.

Advantageously, the occupant's relative position or the relative position of a part of the occupant's body can be determined as a function of the adjusted vehicle seat position, so that the radiation power of the heating surfaces relevant to the warming of the vehicle occupant sitting in the vehicle seat can be adapted to the sitting position by analyzing the sitting position. In this case, the adjusted vehicle seat position may be known either by way of an acknowledgement from the seat adjustment or by way of a camera system provided for this purpose. With respect to details, as a function of the adjusted seat position with respect to the infrared radiator or the relevant decentralized heating surface, the heating power of this heating surface can be specified or influenced such that, with a larger distance between the occupant and the heating element, a greater heating power of the infrared radiator is generated.

Advantageously, the position of the vehicle occupant or of a part of the vehicle occupant's body relative to the at least one relevant heating surface can also be determined as a function of the data of an interior sensing system, particularly a camera system. When, for example, the position of a body part (for example, an arm) can be detected by a camera system, the temperature or the heating power of those infrared radiators which are situated in the respective direct surroundings of the body part, can be correspondingly influenced. In particular, the heating power of a decentralized heating surface or of a group of decentralized heating surfaces can be reduced when the position of the vehicle occupant or of a part of the vehicle occupant's body relative to this heating surface falls below a specified minimum distance. Ideally, several minimum distances may also be defined, so that the heating power is reduced in steps as the distance becomes smaller. As a result, on the one hand, constancy of the driver's thermal feeling can be achieved while energy is saved simultaneously and, at the same time, the danger of burns is reduced, which could occur, for example, in the case of a very narrow distance between the body part and the infrared radiator.

In order to avoid an occupant from possibly suffering burns when he comes in direct contact with an actuated infrared radiator, the heating power of a decentralized heating surface may even be reduced to zero when it is detected that this heating surface is touched by the vehicle occupant. A contact between the vehicle occupant and the heating radiator can be detected by way of the interior sensing system or by analyzing the resistance of the infrared radiator or of the radiation generator and/or by analyzing the current flow through the infrared radiator or the radiation generator when a change of the resistance and/or of the current flow is measured. Advantageously, the switching-off can also be combined with a timer, so that the corresponding heating surface can be switched off only when a longer contact exists between the heating surface and the vehicle occupant.

Advantageously, the radiation power of the infrared radiators can also be adapted to the radiated-back power of the body on which the radiation power impinges; i.e. the heating power of the at least one decentralized heating surface can be influenced as a function of a determined radiated-back heat or heating power or the surface temperature of the vehicle occupant. For this purpose, the surface temperature of one or more body parts can be determined by use of an infrared sensor, and the radiation power or heating power of a decentralized infrared radiator can be increased when the measured surface temperature or the radiated-back radiation power falls.

In particular, the radiation power or temperature of the individual infrared radiators can be adapted according to the position of the radiator relative to the body and according to the shape of the radiator, wherein:

(a) in the case of a long distance, the heating power or the temperature of the radiator is increased, and

(b) in the case of concave shapes of the heating radiator, more heating power should be set than in the case of convex radiators.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a diagrammatic view of the interior of a vehicle with a central heating system and decentralized heating surfaces;

FIG. 2 is a diagrammatic view illustrating the connection between the heating power of a decentralized heating surface and the distance of a part of an occupant's body from this decentralized heating surface; and

FIG. 3 is an extremely simplified flow chart for illustrating a preferred embodiment of the method according to the invention.

### DETAILED DESCRIPTION OF THE DRAWINGS

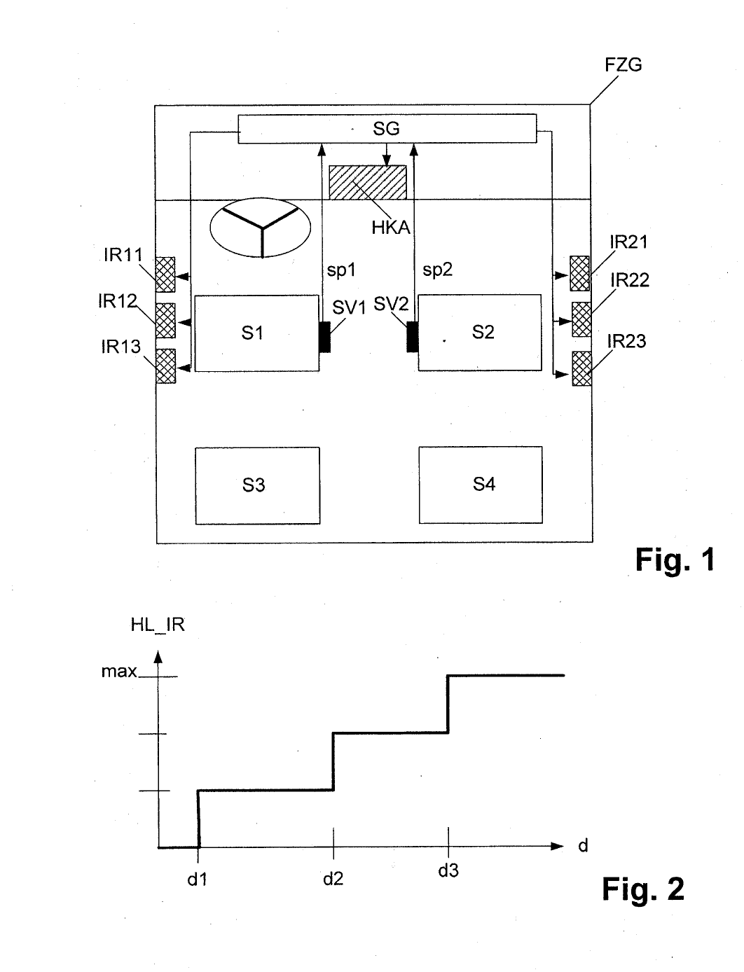

FIG. 1 illustrates a vehicle interior FZG having four seats S1-S4 and a central control device SG for controlling the temperature of the vehicle interior FZG corresponding to a vehicle occupant's heating demand. The vehicle is equipped with a conventional heating air-conditioning system HKA as the central heating system, which can be actuated by the control unit SG for the air conditioning of the vehicle interior corresponding to the heating demands. In addition to the central heating system HKA, six decentralized heating surfaces IR11, IR12, IR13, IR21, IR22 and IR23 are arranged in a distributed manner in the vehicle. The heating surfaces IR11-IR 13 are positioned such that they are used for controlling the temperature of the driver seat area, and the heating surfaces IR21-IR23 are positioned such that they are used for controlling the temperature of the front passenger seat area. Each of the heating surfaces IR11-IR23 may, in turn, consist of several heating surface parts which are installed in the door panel or in the floor space of the corresponding area. Furthermore, the heating surfaces IR11-IR 23 are further developed as so-called infrared radiators and consist of a radiation generator (for example, a foil through which current flows), which generates heat from electric energy and radiates it in the form of infrared radiation.

Finally, the driver seat S1 and the front passenger seat S2 is equipped with an electric seat adjusting unit SV1 or SV2, which each send a seat position signal sp1 or sp2 to the control unit SG.

FIG. 2 illustrates a diagram for showing the connection between the heating power HL_IR of a decentralized heating surface and a distance d of a part of the occupant's body from this decentralized heating surface. When the distance d is shorter than a specified first minimum distance d1, for the purpose of avoiding burns, the heating power HL_IR is reduced to zero; i.e. the infrared radiator is switched off. Depending on the distance d or the exceeding of the specified distance values d1, d2 or d3, the power HL_IR of the heating surface is increased in steps until, when the distance value d3 is exceeded, it is operated with a maximum heating power “max” as a function of the heating demand.

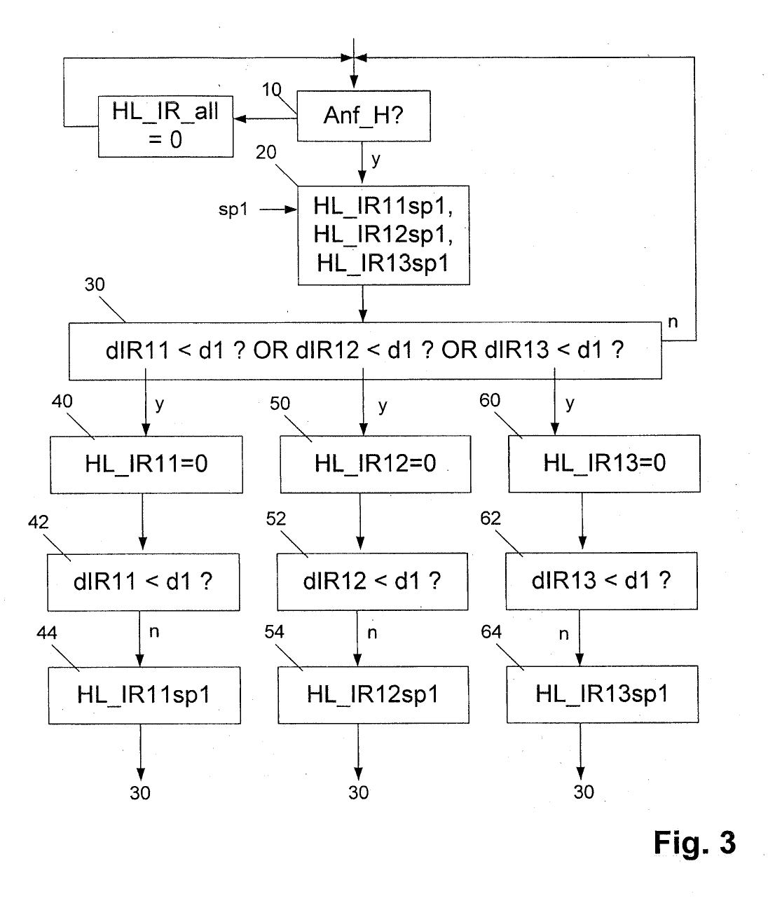

FIG. 3 illustrates a simplified flow chart for showing a preferred embodiment of the method according to the invention, wherein, in this example, only an actuating for three heating surfaces is shown, which are used for controlling the temperature in the area of the driver seat (compare heating surfaces IR11, IR12 and IR13 from FIG. 1).

The process starts in Step 10. As long as no heating demand Anf_H is detected, the heating power HL_IR of all heating surfaces remains at zero or is reduced to zero; i.e. they remain (or are) switched off. As soon as a demand for heating the vehicle interior Anf_H is detected, in the next Step 20, as a function of the data transmitted by the seat adjusting unit concerning the current seat position sp1 of the driver seat for the three decentralized heating surfaces IR11, IR12 and IR13 (from FIG. 1), a heating power HL_IR11sp1, HL_IR12sp1 and HL_IR13sp1 required corresponding to the heating demand Anf_H is determined for these decentralized heating surfaces. It is decisive in this case that, for each of these heating surfaces IR11, IR12 and IR13, such a heating power HL_IR11sp1, HL_IR12sp1 and HL_IR13sp1 is specified, that the occurring thermal power generated by the heating power HL_IR11sp1, HL_IR12sp1 and HL_IR13sp1 at the driver is at least almost equal for all areas of the driver exposed to the radiation. When the driver seat is, for example, in the most forward seat position, the most forward heating surface IR11, as required, is actuated with a lower heating power HL_IR11sp1 than the most rearward heating surface IR13 because the driver's legs are probably closer to the most forward heating surface IR11 than the driver's back is on the rear heating surface IR13. In the inverse case, when the driver seat is in the rearward seat position, the most forward heating surface IR11 is actuated, as required, with a higher heating power HL_IR11SP1; thus the rear heating surface IR13, because the driver's back is probably closer to the rear heating surface IR13 than the driver's legs are to the forward heating surface IR11.

After the determination of the required heating powers HL_IR11sp1, HL_IR12sp1 and HL_IR13sp1 of the three heating surfaces and starting a corresponding actuation of these heating surfaces IR11, IR12 and IR13, a change takes place to Step 30. For safety reasons, it is checked in step 30 whether the distance between a part of the driver's body and one of the infrared heating surfaces falls below a specified minimum distance d1. It is concretely checked whether the distance dIR11 between a part of the driver's body and the most forward heating surface IR11 falls below the specified minimum distance d1, or whether the distance dIR12 between a part of the driver's body and the center heating surface IR12 falls below the specified minimum distance d1, or whether the distance dIR13 between a part of the driver's body and the rearward heating surface IR falls below a specified minimum distance d1.

If the distance dIR11 between a part of the driver's body and the most forward heating surface IR11 falls below the specified minimum distance d1, a jump takes place from Step 30 to Step 40, and the heating power HL_IR11 of this heating surface is reduced to zero; the heating surface is therefore switched off in order to prevent an overheating of the body part that is possibly uncomfortable to the driver, or even to prevent burns of the body part. When the distance dIR12 between the part of the driver's body and the center heating surface IR12 falls below the specified minimum distance d1, a jump takes place from Step 30 to Step 50, and the heating power HL_IR12 of this heating surface is reduced to zero. Analogously, in the case of a falling-below the specified minimum value d1 between a part of the driver's body and the rear heating surface IR13, a jump takes place from Step 30 to Step 60, and the heating power HL_IR13 of this heating surface is reduced to zero; the heating surface is therefore switched off.

When one of the heating surfaces is switched off, a change subsequently takes place from Step 40, 50 or 60 to the respective next Step 42, 52 or 62, and it is checked there again whether the distance dIR11, dIR12 or dIR13 between a body part and a relevant heating surface IR1, IR2 or IR3 is still shorter than the specified minimum distance d1. If this is no longer the case, a change takes place to the next Step 44, 54 or 64, and the heating power HL_IR11sp1, HL_IR12sp1 or HL_IR13sp1 determined above in Step 20 is set again. Finally, a return to Step 30 then takes place.

When the process is (again) in Step 30, and there is no falling below the minimum distance d1 at any heating surface because of the position of a body part, a jump takes place from Step 30 to the start of the process.

By way of the method according to the invention presented here and its advantageous further developments, in a simple and cost-effective manner, an optimal comfort and, by use of the infrared heating surfaces, a clearly faster reaching of thermal comfort can be ensured while the electric energy consumption is low. In addition, the efficiency of the decentralized heating surfaces is increased because the infrared radiation is controlled according to the demand. The occurrence of pain or even burns can further be reliably avoided, in the event of (extended) contact with the heating surfaces.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of heating an interior of a vehicle equipped with a central heating system and several decentralized heating surfaces in the form of infrared radiators, the method comprising the acts of:
controlling a temperature of the vehicle interior by the central heating system and/or the decentralized heating surfaces corresponding to a heating demand, wherein
for controlling the temperature of the interior, specifying or influencing a heating power of at least one decentralized heating surface as a function of a position of a vehicle occupant or a part of a vehicle occupant's body relative to the respective decentralized heating surface or a defined group of several decentralized heating surfaces.

2. The method according to claim 1, wherein the specifying or influencing of the heating power is performed as a function of a distance between the vehicle occupant or the part of the vehicle occupant's body and the respective decentralized heating surface or the defined group of several decentralized heating surfaces.

3. The method according to claim 2, wherein the specifying or influencing of the heating power is such that warmth impinging on the vehicle occupant or a warmth feeling on all sides of the body of the vehicle occupant exposed to radiation of the decentralized heating surfaces is almost equal.

4. The method according to claim 1, wherein the specifying or influencing of the heating power is such that warmth impinging on the vehicle occupant in an event of a changing relative position of the vehicle occupant or a part of the vehicle occupant's body during a heating demand, remains substantially constant.

5. The method according to claim 1, further comprising the act of:
determining a relative position of the vehicle occupant as a function of a set vehicle seat position.

6. The method according to claim 1, further comprising the act of:
determining a relative position of the vehicle occupant or a part of the vehicle occupant's body as a function of data from an interior sensing system.

7. The method according to claim 6, wherein the interior sensing system is a camera system.

8. The method according to claim 1, further comprising the acts of:
reducing the heating power of a decentralized heating surface or a group of the decentralized heating surfaces when a distance of the vehicle occupant or a part of the vehicle occupant's body from the respective heating surface or a heating surface of the respective group of heating surfaces falls below a specified minimum distance.

9. The method according to claim 1, further comprising the act of:
reducing the heating power of a decentralized heating surface to zero when the respective heating surface is in contact with the vehicle occupant.

10. The method according to claim 9, wherein contacting of the heating surface is detectable by analyzing a resistance of the infrared radiator of the decentralized heating surface and/or of a current flow through the infrared radiator of the decentralized heating surface.

11. The method according to claim 1, wherein the heating power of the decentralized heating surface is influenced as a function of a determined radiated heat or of one or more surface temperatures of the vehicle occupant.

12. The method according to claim 11, wherein the one or more surface temperatures of the vehicle occupant are measured by an IR sensor, said IR sensor being arranged close to the heating surface.

13. The method according to claim 1, wherein the vehicle is a hybrid or electric vehicle.
